(19) United States
(12) Patent Application Publication
(10) Pub. No.: US 2026/0227927 A1
(43) Pub. Date: Aug. 6, 2026

(54) METHOD AND SYSTEM FOR LOW-LATENCY DATA PROCESSING BASED ON DISTRIBUTED STORAGE USING CXL INTERFACE

(71) Applicant: D.notitia.Inc., Seongnam-si (KR)

(72) Inventors: Byong John HAN, Seoul (KR); Hong Chan Roh, Seoul (KR); Dae Gon Yang, Seoul (KR); Dong Gyu Park, Seoul (KR); Keun Woo Lim, Seoul (KR); Jong Hyuk Im, Seoul (KR)

(73) Assignee: D.notitia.Inc., Seongnam-si (KR)

(21) Appl. No.: 19/414,901

(22) Filed: Dec. 10, 2025

(30) Foreign Application Priority Data
Feb. 6, 2025 (KR) 10-2025-0015429

(51) Int. Cl. G06F 3/06

(52) U.S. Cl. CPC G06F 3/0655; G06F 3/061; G06F 3/0679

(57) ABSTRACT

A method for low-latency data processing based on distributed storage using a high-speed communication interface, which is performed in a distributed storage system including a plurality of hosts, includes communicatively connecting a source host and a target host through a first communication interface and a second communication interface, transmitting a command from the source host to the target host through the first communication interface, and transmitting data to the target host from the source host through a shared memory of a switch device by using the second communication interface. A speed of the second communication interface is higher than a speed of the first communication interface, and a delay of the second communication interface is lower than a delay of the first communication interface.

### CROSS-REFERENCE TO RELATED APPLICATIONS

This application claims priority under 35 U.S.C. § 119 to Korean Patent Application No. 10-2025-0015429 filed on Feb. 6, 2025, in the Korean Intellectual Property Office, the disclosures of which are incorporated by reference herein in their entireties.

### BACKGROUND

Embodiments of the present disclosure described herein relate to a technology for processing data in a distributed storage environment, and more particularly, relate to a technology for processing or optimizing data replica and data rebalancing at a high speed between storage devices in the distributed storage environment by utilizing a compute express link (CXL) interface in a computing system.

As the cloud becomes popular, the use of distributed storage is increasing. As a technology for managing the distributed storage, a software-based storage management technology to manage a plurality of distributed physical storage, for example, a plurality of host computers in one logical environment is being used.

In a conventional software-defined storage (SDS) system where the storage management technology is used, each node, that is, a storage device of a host computer, is directly connected to an operating system of the corresponding node to process the input/output (I/O). In this case, data transmission between nodes is performed through the Ethernet during data replica or background data rebalancing, resulting in the reduction of performance and delay.

That is, because the conventional manner has limitations such as I/O delay due to network bottleneck, inefficient background data rebalancing, and the absence of a direct replica manner, a lot of time and resources for data replica and data rebalancing are required.

Accordingly, there is a great need to improve the limitations of the Ethernet-based physical storage system.

### SUMMARY

Embodiments of the present disclosure provide a method and a system for low-latency data processing based on distributed storage using a high-speed communication interface, which are capable of improving a data replica process and a data rebalancing process by using a CXL device and providing data replica and data rebalancing faster and more efficiently through a direct memory loading-based data processing function.

Embodiments of the present disclosure provide a method and a system for low-latency data processing based on distributed storage using a CXL interface, which are capable of allowing data loaded on a memory device to be directly replicated to storage of a host by mapping a plurality of storage present in different hosts through a common memory device by utilizing a CXL interface such that data processing is directly performed between the plurality of storage.

Embodiments of the present disclosure provide a method and a system for low-latency data processing based on distributed storage using a CXL interface, which are capable of processing data at a high speed without bottleneck by using Ethernet communication to transmit commands between a plurality of hosts and a CXL device and by utilizing a CXL interface for data processing.

Problems to be solved by the present disclosure are not limited to the above problems, and other problems not mentioned herein may be clearly understood from the specification and the accompanying drawings by one skilled in the art to which the present disclosure pertains.

According to an embodiment, a method for low-latency data processing based on distributed storage using a high-speed communication interface, which is performed in a distributed storage system including a plurality of hosts, may include communicatively connecting a source host and a target host through a first communication interface and a second communication interface, transmitting a command from the source host to the target host through the first communication interface, and transmitting data to the target host from the source host through a shared memory of a switch device by using the second communication interface. A speed of the second communication interface may be higher than a speed of the first communication interface, and a delay of the second communication interface may be lower than a delay of the first communication interface.

In an embodiment, the first communication interface may be a network interface card (NIC)-based communication interface, and the second communication interface may be a compute express link (CXL)-based communication interface.

In an embodiment, the communicatively connecting of the source host and the target host through the first communication interface and the second communication interface may include communicatively connecting the source host and the target host by using the NIC-based communication interface, and communicatively connecting the source host, the target host, and the switch device by using the CXL-based communication interface.

In an embodiment, the switch device may internally include the shared memory, and each of the source host and the target host may include storage individually.

In an embodiment, when the data are transmitted to the target host from the source host through the shared memory of the switch device, the data may be stored from the shared memory of the switch device directly to storage of the source host without loading the data to a memory of the source host, or the data may be stored from the shared memory of the switch device directly to storage of the target host without loading the data to a memory of the target host.

In an embodiment, the transmitting of the data to the target host from the source host through the shared memory of the switch device may include loading first data received by the source host as a replica target to the shared memory of the switch device so as to be replicated to the source host and the target host.

In an embodiment, the loading of the first data received by the source host as the replica target to the shared memory of the switch device so as to be replicated to the source host and the target host may include receiving, at the source host, the first data from a client, providing, at the source host, the first data to the switch device through the second communication interface, wherein the first data provided to the switch device are loaded to the shared memory by the switch device, and receiving, at the source host, the first data loaded to the shared memory of the switch device from the switch device through the second communication interface so as to be directly stored to storage of the source host.

In an embodiment, the loading of the first data received by the source host as the replica target to the shared memory of the switch device so as to be replicated to the source host and the target host may further include receiving, at the target host, the first data loaded to the shared memory of the switch device from the switch device through the second communication interface so as to be directly stored to storage of the target host.

In an embodiment, the transmitting of the data to the target host from the source host through the shared memory of the switch device may include loading second data stored in storage of the source host as a rebalancing target to the shared memory of the switch device so as to be rebalanced to the target host.

In an embodiment, the loading of the second data stored in the storage of the source host as the rebalancing target to the shared memory of the switch device so as to be rebalanced to the target host may include loading the second data stored to the storage of the source host to the shared memory of the switch device through the second communication interface, and receiving, at the target host, the second data loaded to the shared memory of the switch device from the switch device through the second communication interface so as to be directly stored to storage of the target host.

According to an embodiment, a system for low-latency data processing based on distributed storage using a high-speed communication interface may include a source host, a target host that is communicatively connected to the source host through a first communication interface and a second communication interface, and a switch device that is communicatively connected to the source host and the target host through the second communication interface and internally including a shared memory. A command may be transmitted to the target host from the source host through the first communication interface, and data may be transmitted to the target host from the source host through the shared memory of the switch device by using the second communication interface. A speed of the second communication interface may be higher than a speed of the first communication interface, and a delay of the second communication interface may be lower than a delay of the first communication interface.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other aspects of the present disclosure will become apparent to those of ordinary skill in the art by describing exemplary embodiments thereof in detail with reference to the accompanying drawings.

FIG. 1 is a diagram illustrating a system for low-latency data processing based on distributed storage using a high-speed communication interface, according to an embodiment of the present disclosure.

FIG. 2 is a diagram illustrating a configuration of a system for low-latency data processing based on distributed storage, according to an embodiment of the present disclosure.

FIG. 3 is a diagram illustrating a data replica process in a data processing system illustrated in FIG. 2.

FIG. 4 is a diagram illustrating a data rebalancing process in a data processing system illustrated in FIG. 2.

FIG. 5 is a diagram illustrating a configuration of a system for low-latency data processing based on distributed storage using a high-speed communication interface, according to another embodiment of the present disclosure.

FIG. 6 is a flowchart describing a method for low-latency data processing based on distributed storage using a high-speed communication interface in a data processing system illustrated in FIG. 5.

FIG. 7 is a flowchart illustrating a method for communication connection through a communication interface in a data processing system illustrated in FIG. 5.

FIG. 8 is a diagram illustrating a data replica process in a data processing system illustrated in FIG. 5.

FIG. 9 is a flowchart illustrating a data replica method based on distributed storage using a high-speed communication interface illustrated in FIG. 8.

FIG. 10 is a diagram illustrating a data balancing process in a data processing system illustrated in FIG. 5.

FIG. 11 is a flowchart illustrating a method for data rebalancing based on distributed storage using a high-speed communication interface illustrated in FIG. 10.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

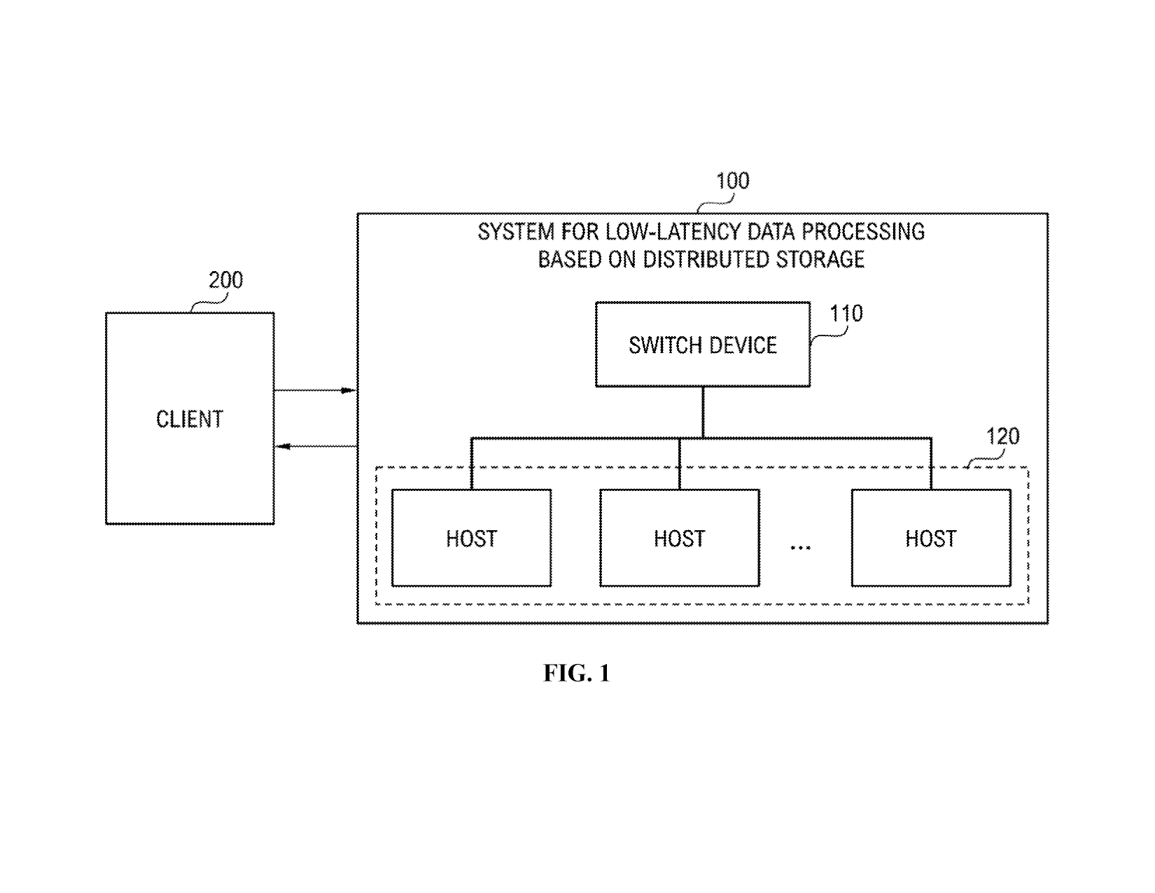

FIG. 1 is a diagram illustrating a system (hereinafter referred to as a “data processing system”) for low-latency data processing based on distributed storage using a high-speed communication interface, according to an embodiment of the present disclosure.

Referring to FIG. 1, a data processing system 100 may include a switch device 110 and a plurality of hosts 120.

Each of the plurality of hosts 120 may be a computing device including storage. Various data processing such as access, processing, move, replica, and rebalancing may be performed between the plurality of hosts 120.

A client 200 may perform replica of data or the like through the data processing system 100, and the data processing system 100 may perform rebalancing for data based on an algorithm included in the data processing system 100 or depending on a request of the client 200.

As an example, depending on a given period or an event (e.g., node addition, device failure), the data processing system 100 starts background data rebalancing through a storage process.

The switch device 110 is communicatively connected to the plurality of hosts 120. When data are transmitted (e.g., replicated or rebalanced) between the hosts 120, the data transmission between the hosts 120 may be processed through the switch device 110.

In an embodiment of the present disclosure, the switch device 110 may include a memory therein and may perform data transmission by using the memory. In the following description, the memory included in the switch device 110 may be referred to as a “shared memory”.

In an embodiment of the present disclosure, the switch device 110 and the plurality of hosts 120 connected to the switch device 110 may be connected based on a high-speed communication interface and may perform data processing. For example, the high-speed communication interface may be a CXL-based communication interface.

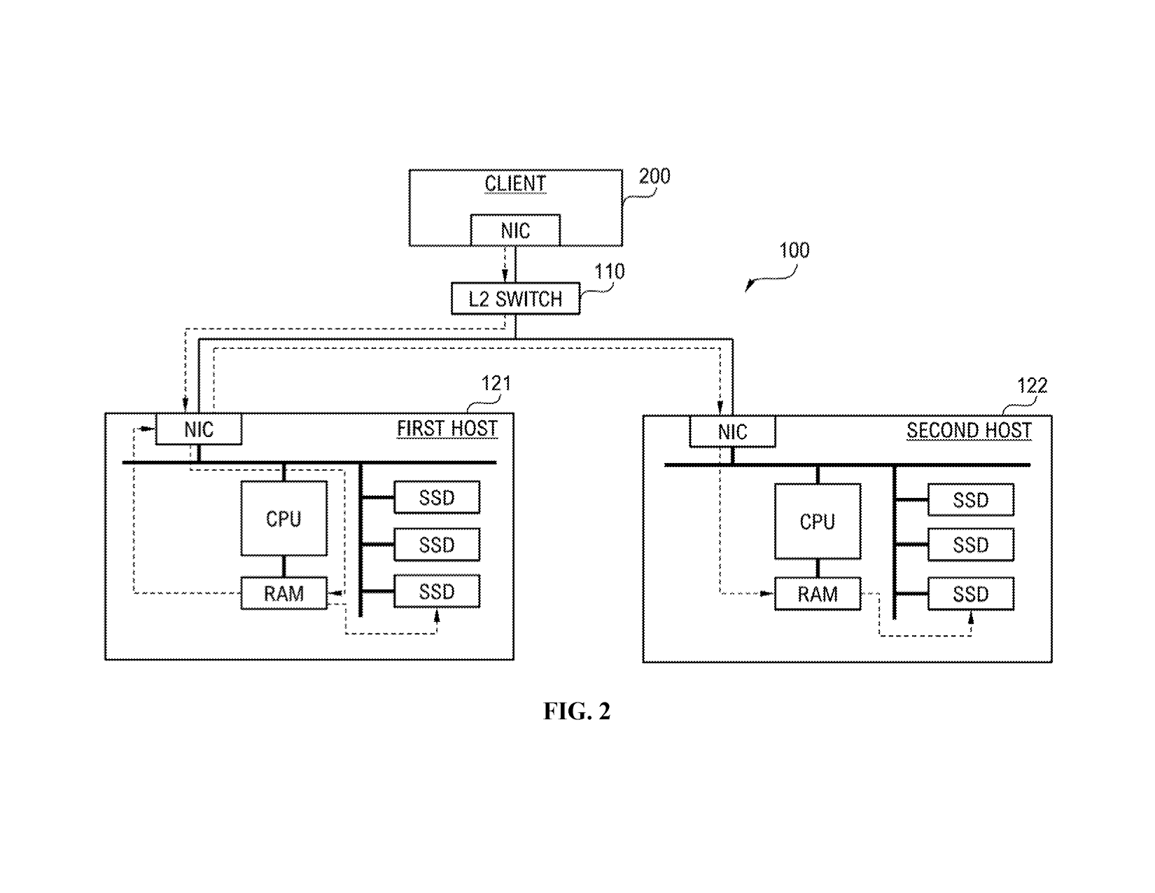

Below, various embodiments of a system and a method for low-latency data processing based on distributed storage using the high-speed communication interface according to the present disclosure will be described in detail with reference to FIGS. 2 to 11.

FIG. 2 is a diagram illustrating a configuration of a system for low-latency data processing based on distributed storage, according to an embodiment of the present disclosure.

FIG. 2 is associated with an embodiment where the switch device 110 does not include a memory (or an internal memory). A first host 121, a second host 122, and the switch device 110 may be connected by a conventional communication interface (e.g., a network interface card (NIC)), and commands and data may be transmitted/received through the conventional communication interface.

In FIG. 2, a dotted line indicates a process in which commands and data are transferred when data replica or the like is requested through the client 200. In FIG. 2, the first host 121 is a source host, and the second host 122 is a target host. After data loaded to a memory (e.g., an RAM) of the first host 121 through the communication interface are again stored in storage (e.g., an SSD) of the first host 121, the data loaded to the memory of the first host 121 are loaded to a memory (e.g., an RAM) of the second host 122 through the communication interface, and the data loaded to the memory of the second host 122 are again stored in storage (e.g., an SSD) of the second host 122.

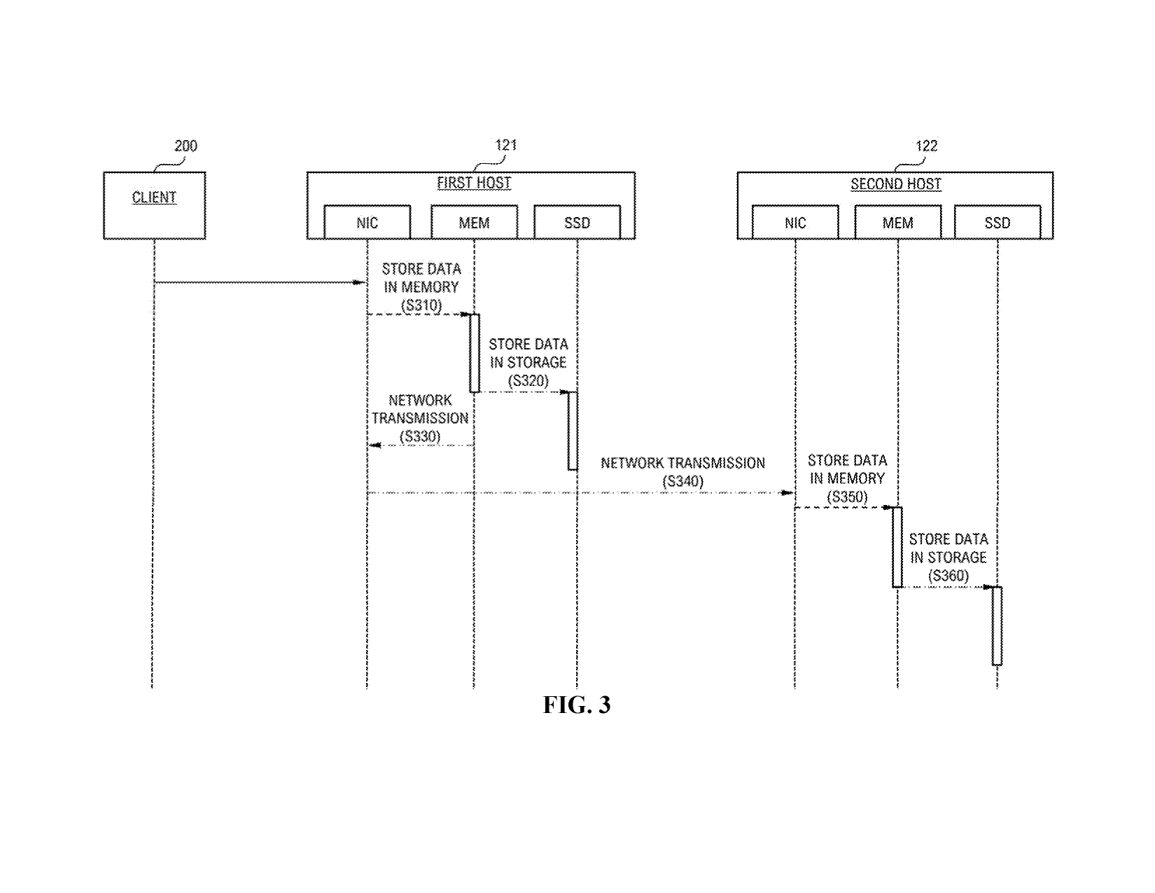

FIG. 3 is a diagram illustrating a data replica process in a data processing system illustrated in FIG. 2.

Referring to FIG. 3, the client 200 provides a data replica command and replica target data to the first host 121 being a source host.

Afterwards, the first host 121 loads the data received from the client 200 to the memory of the first host 121 (S310) and again stores the data loaded to the memory of the first host 121 in the storage of the first host 121 (S320).

Also, the first host 121 transmits the data loaded to the memory of the first host 121 to the second host 122 through the communication interface (S330 and S340).

The second host 122 loads the data received through the network to the memory of the second host 122 (S350) and again stores the data loaded to the memory of the second host 122 in the storage of the second host 122 (S360).

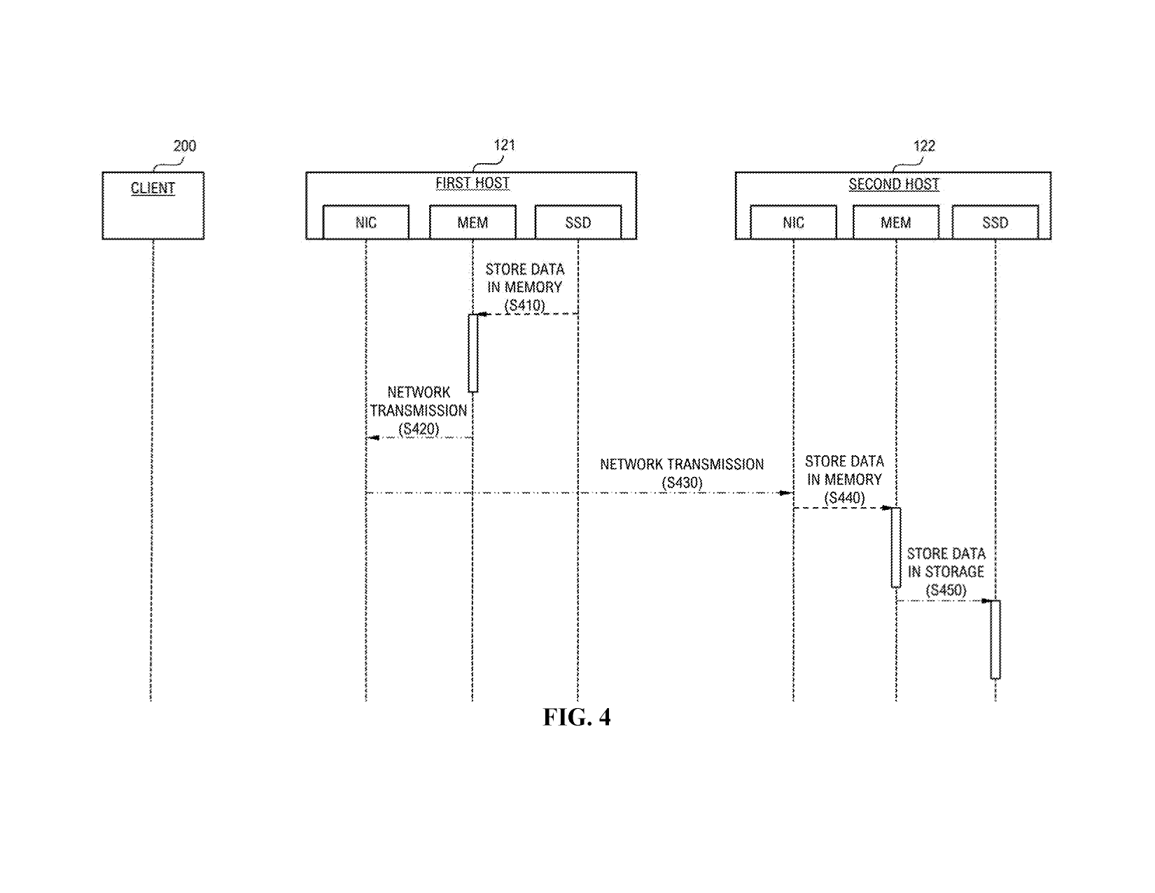

FIG. 4 is a diagram illustrating a data rebalancing process in a data processing system illustrated in FIG. 2.

FIG. 4 shows an example of a process in which data rebalancing from the first host 121 being a source host to the second host 122 being a target host is performed.

Although not illustrated in FIG. 4, the rebalancing may be triggered depending on the storage process or the event; in this case, a rebalancing command may be provided to the first host 121 and the second host 122.

FIG. 4 shows an example of the movement of rebalancing target data. The first host 121 receiving the rebalancing command loads the rebalancing target data stored in the storage in the first host 121 to the memory of the first host 121 (S410).

Afterwards, the first host 121 transmits the data loaded to the memory of the first host 121 to the second host 122 through the network (S420 and S430).

After the second host 122 loads the data received through the network to the memory of the second host 122 (S440), the second host 122 performs a process of again storing the data loaded to the memory of the second host 122 in the storage of the second host 122 (S450).

In the embodiment described with reference to FIGS. 2 to 4, the data transmission is directly processed between the first host 121 and the second host 122. That is, the switch device 110 exists between the first host 121 and the second host 122, but the switch device 110 only performs switching for data transmission processing without performing data storage processing or the like.

In the embodiment described with reference to FIGS. 2 to 4, in the case of data replica or data rebalancing, a memory loading process is necessarily performed in a host.

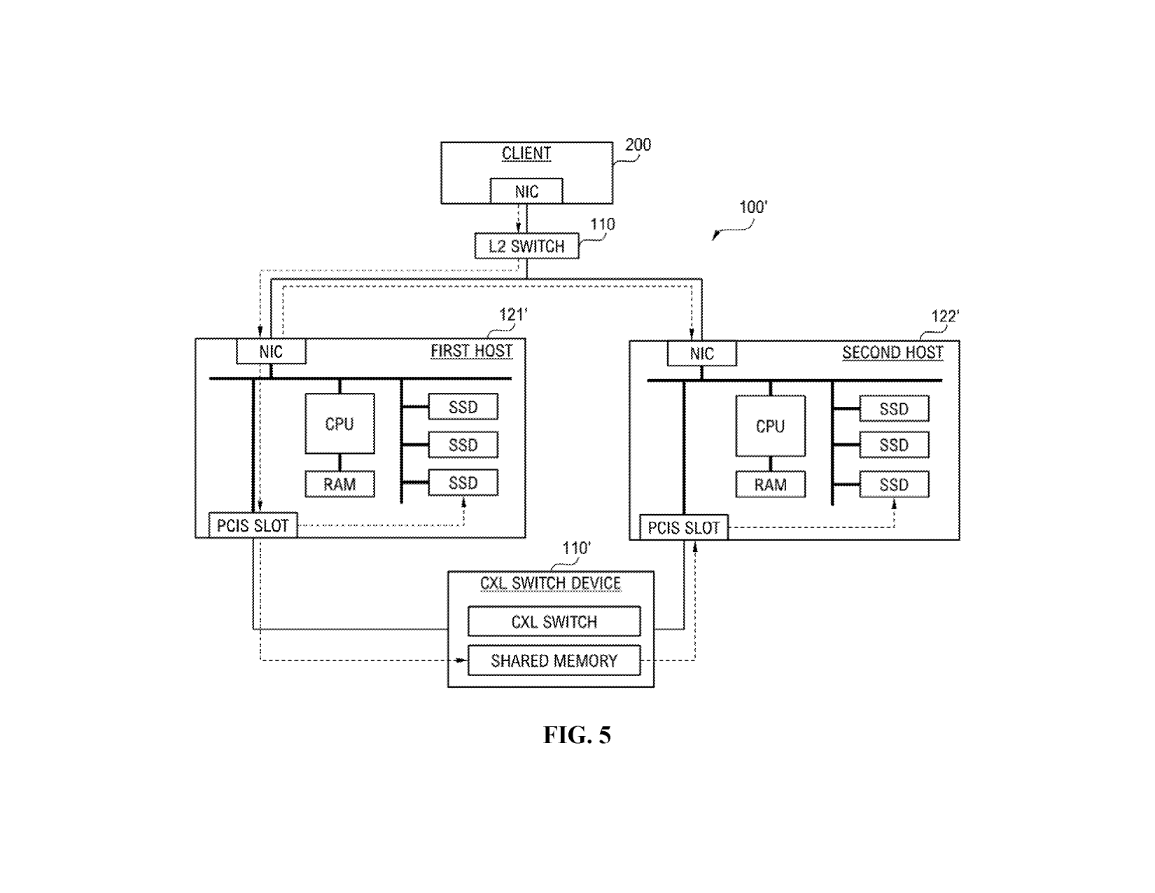

Meanwhile, in an embodiment to be described with reference to FIGS. 5 to 11, data transmission processing is performed by using a shared memory which a switch device internally includes. Also, each of a plurality of hosts may separately use a high-speed communication interface for data communication with the switch device, and thus, data processing, data replica, or background data rebalancing may be performed faster and more efficiently. Below, the description will be given in detail with reference to FIGS. 5 to 11.

FIG. 5 is a diagram illustrating a configuration of a system for low-latency data processing based on distributed storage using a high-speed communication interface, according to another embodiment of the present disclosure.

Referring to FIG. 5, the data processing system 100' includes a first host 121’, a second host 122’, and a CXL switch device 110’. In the following description, the first host 121’ may be referred to as a “source host”, and the second host 122’ may be referred to as a “target host”. Accordingly, the same reference numeral 121’ may be used for a first host and a source host, and the same reference numeral 122’ may be used for a second host and a target host.

In the data processing system 100’ of FIG. 5, each of the first host 121’ and the second host 122’ uses a plurality of communication interfaces. The plurality of communication interfaces may include a first communication interface and a second communication interface.

In detail, in the first host 121’ and the second host 122’, the first communication interface which is connected to the client 200 may be a conventional communication interface, for example, an NIC-based communication interface. The first communication interface is used to receive commands or data from the client 200 or is used to transmit commands between hosts. In FIG. 5, a dotted line connected from the NIC of the first host 121’ to the NIC of the second host 122’ shows an example of a process in which the commands are transmitted between the first host 121’ and the second host 122’.

In the first host 121’ and the second host 122’, the second communication interface which is connected to the CXL switch device 110’ may be a high-speed communication interface, for example, a CXL-based communication interface. In FIG. 5, each of the first host 121’ and the second host 122’ is connected to the CXL switch device 110’ via the CXL interface using a PCIe slot.

The data transmission (e.g., data replica or background data rebalancing) between hosts is performed through the CXL switch device 110’. In particular, the CXL switch device 110’ internally includes a shared memory.

As understood from the dotted line of FIG. 5, in the data transmission between hosts, data processing may be performed by using the shared memory of the CXL switch device 110’. That is, data stored in storage of any one host may be processed not in a manner where the data are loaded to a memory of the corresponding host, but in a manner where the data are provided directly to storage of the other host after being directly loaded to the shared memory of the CXL switch device 110’.

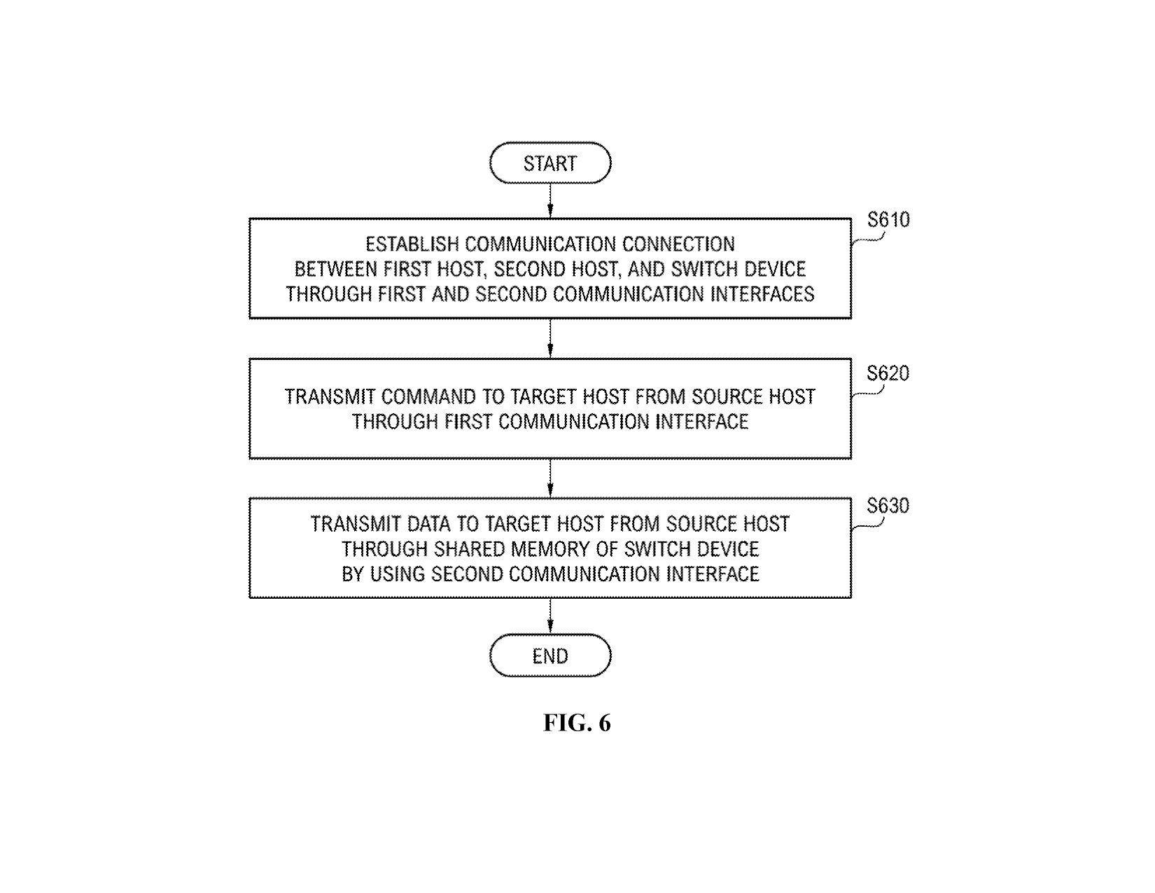

FIG. 6 is a flowchart describing a method for low-latency data processing based on distributed storage using a high-speed communication interface in a data processing system illustrated in FIG. 5.

Referring further to FIG. 6, as already described with reference to FIG. 5, the communication connection between the first host 121’, the second host 122’, and the CXL switch device 110’ may be established through the first communication interface and the second communication interface (S610).

Afterwards, a command is transmitted from the first host 121’ being a source host to the second host 122’ being a target host through the first communication interface (S620). For example, a command for replica processing or rebalancing processing may be transmitted. That is, the command may be transmitted through the first communication interface being a conventional communication interface.

Afterwards, the data transmission from the source host 121’ to the target host 122’ through a shared memory of a switch device may be performed using the second communication interface (S630). In other words, the command may be transmitted through the first communication interface being a conventional communication interface, and the data transmission may be performed through the second communication interface being a high-speed communication interface.

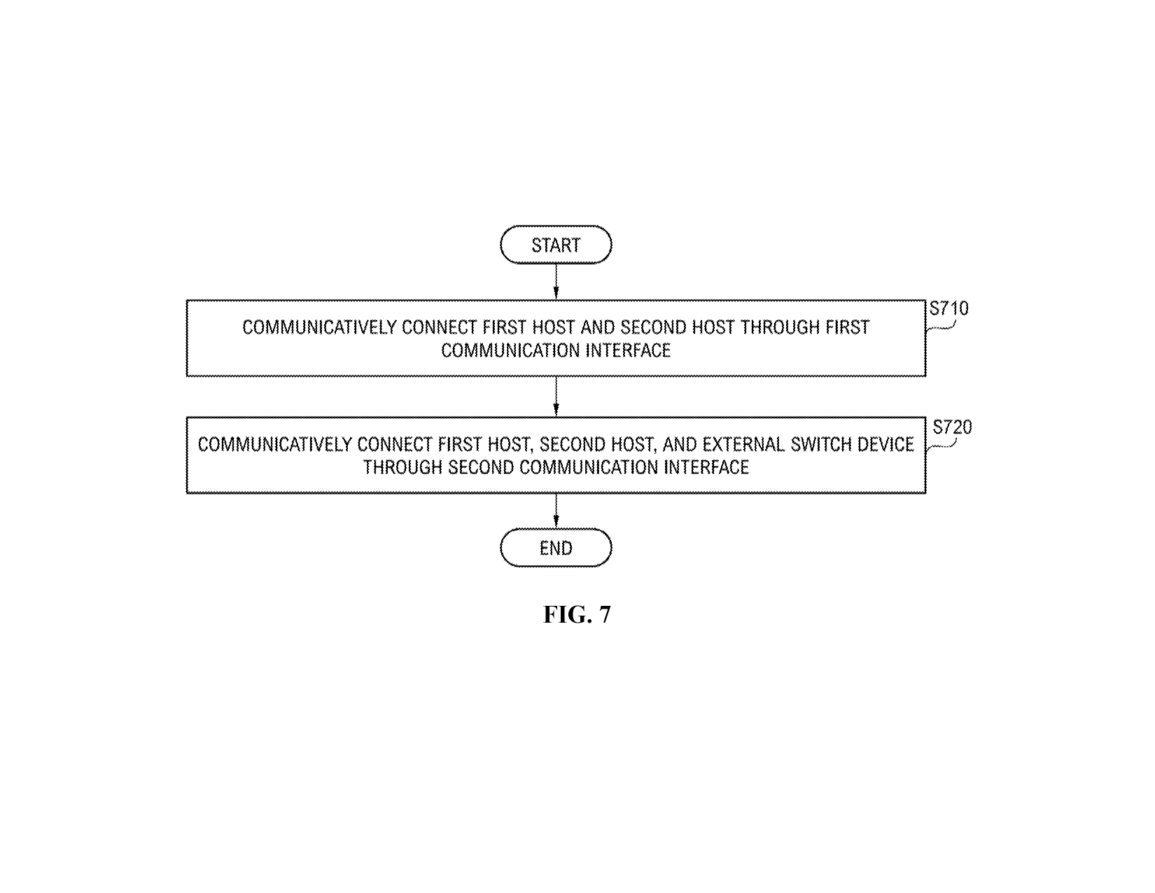

FIG. 7 is a flowchart illustrating a method for communication connection through a communication interface in a data processing system illustrated in FIG. 5.

Referring to FIG. 7, the first host 121’ and the second host 122’ may be communicatively connected through the first communication interface (S710). The first communication interface may be, for example, an NIC-based communication interface; in this case, commands may be transmitted between hosts through the first communication interface, or commands or data may be transmitted/received to/from an external client through the first communication interface.

The first host 121’, the second host 122’, and the CXL switch device 110’ being an external switch device may be communicatively connected through the second communication interface being a high-speed communication interface, for example, a CXL-based communication interface, and the data transmission processing described above may be performed through the second communication interface.

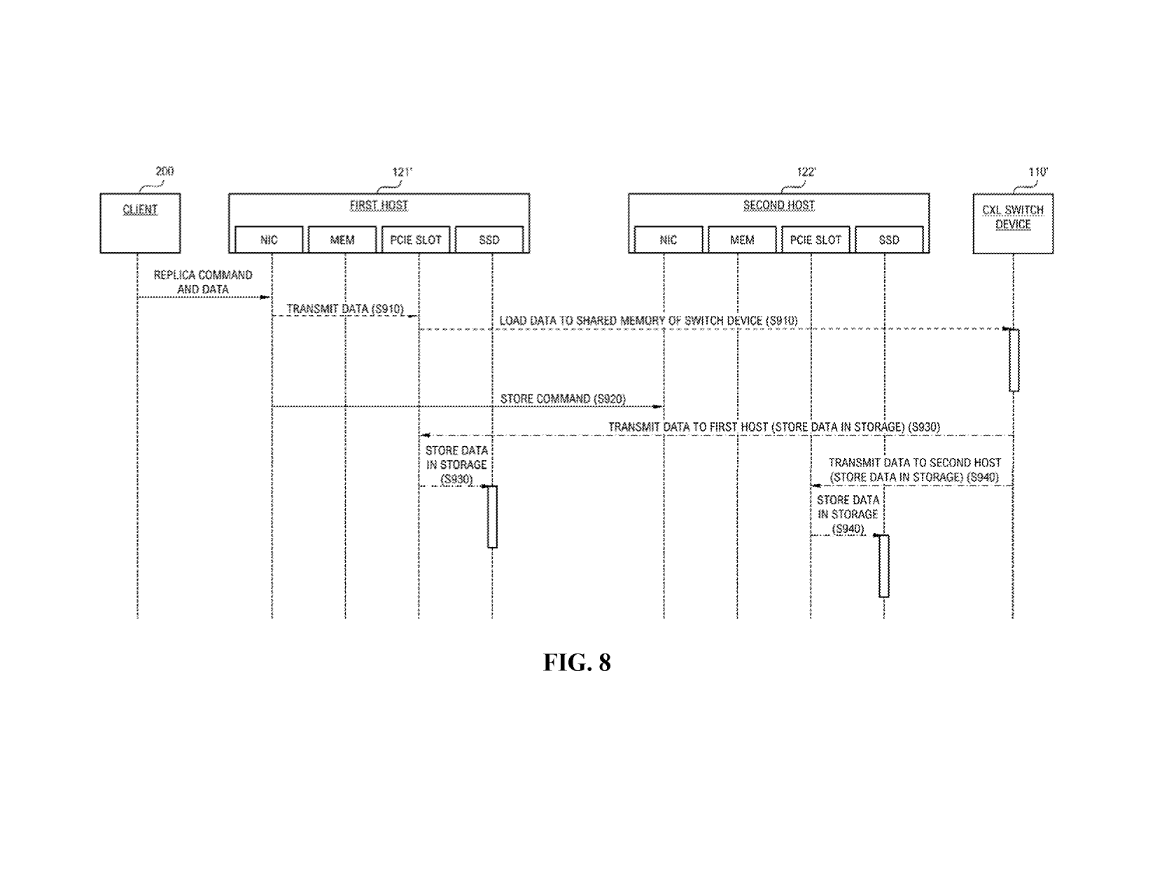

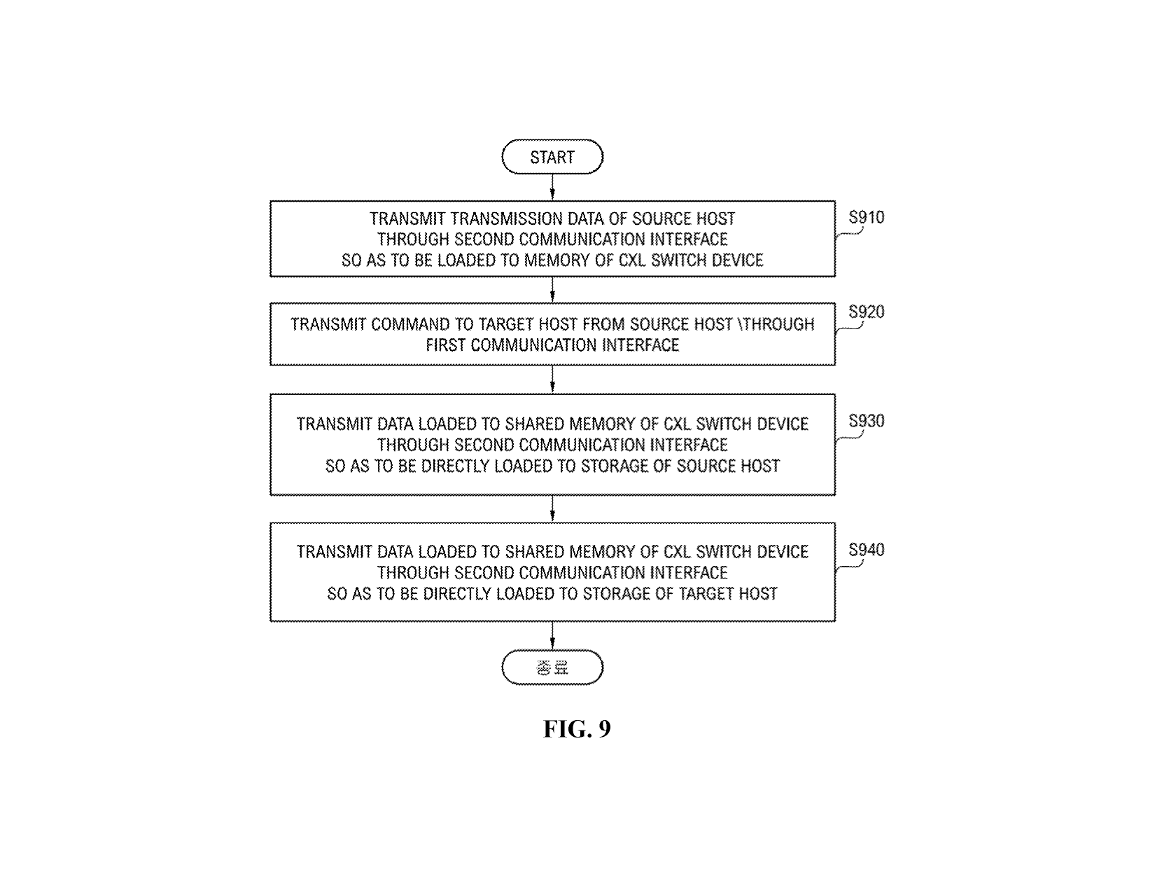

FIG. 8 is a diagram illustrating a data replica process in a data processing system illustrated in FIG. 5, and FIG. 9 is a flowchart illustrating a data replica method based on distributed storage using a high-speed communication interface illustrated in FIG. 8.

Referring to FIGS. 8 and 9, a replica command and replica target data may be transmitted from the client 200 to the first host 121’ being a source host.

Afterwards, the source host may transmit transmission data (i.e., the replica target data) of the source host through the second communication interface being a high-speed communication interface so as to be directly loaded to the shared memory of the CXL switch device 110’ (S910). That is, the replica target data may be loaded directly to the shared memory of the CXL switch device 110’ without the process of loading the data to the memory of the first host 121’.

Afterwards, the replica command (store command) may be transmitted from the first host 121’ being a source host to the second host 122’ being a target host, and the transmission of the replica command may be made through the first communication interface (S920).

Afterwards, the CXL switch device 110’ may provide the data (i.e., the replica target data) loaded to the shared memory to the source host 121’ such that the data are directly stored in the storage of the source host 121’ (S930). The above process of transmitting and storing data, that is, the above execution process may be defined depending on a command provided in advance or a preset protocol.

Likewise, the CXL switch device 110’ may provide the data loaded to the shared memory to the target host 122’ through the high-speed communication interface such that data are directly stored in the storage of the target host 122’ (S940). The above process of transmitting and storing the replica target data, that is, the above execution process may be defined depending on a command provided in advance or a preset protocol.

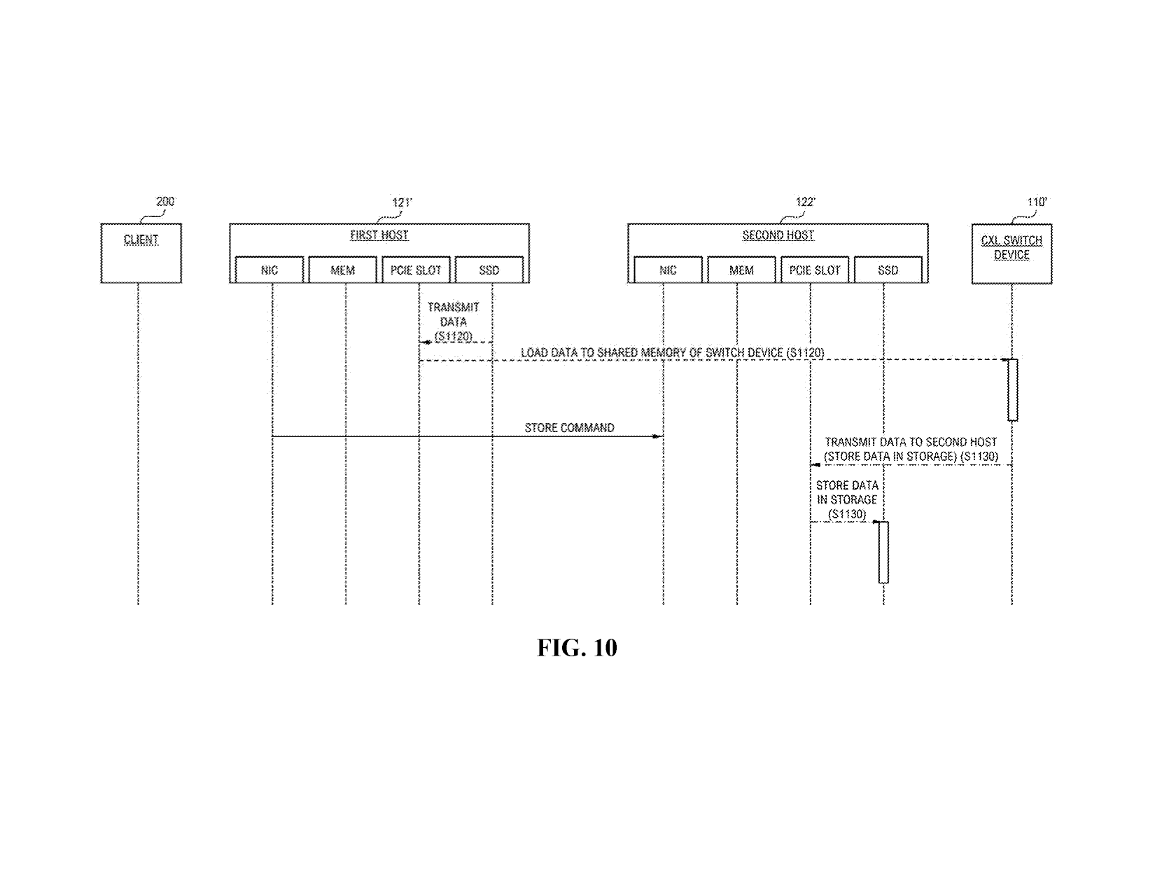

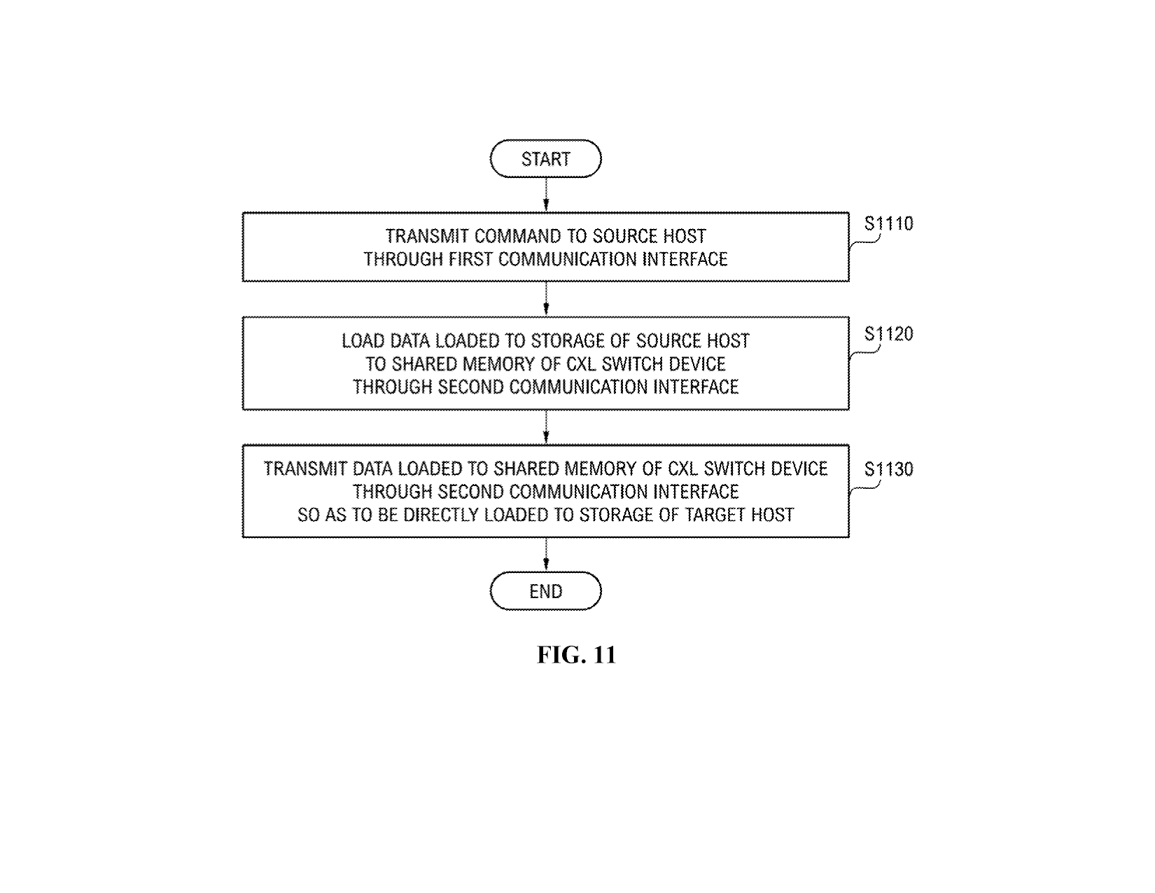

FIG. 10 is a diagram illustrating a data balancing process in a data processing system illustrated in FIG. 5, and FIG. 11 is a flowchart illustrating a distributed storage-based data rebalancing method using a high-speed communication interface illustrated in FIG. 10.

Although not illustrated in FIG. 10, the rebalancing command or the like may be provided to the first host 121’ being a source host by the switch process or the event, the rebalancing command may be transmitted through the conventional communication interface, that is, the first communication interface as described above (S1110).

The source host 121’ may load the rebalancing target data loaded to the storage of the source host 121’ to the shared memory of the CXL switch device 110’ through the high-speed communication interface such that the rebalancing target data loaded to the storage of the source host 121’ are provided to the second host 122’ (S1120). That is, the data loaded to the storage of the source host 121’ may be loaded directly to the shared memory of the CXL switch device 110’ through the high-speed communication interface without the process of loading the data to the memory of the source host 121’.

Afterwards, the replica command (store command) may be transmitted from the source host 121’ to the target host 122’ through the first communication interface. Afterwards, the CXL switch device 110’ may transmit the data loaded to the shared memory of the CXL switch device 110’ to the target host 122’ through the high-speed communication interface, and the target host 122’ may immediately store the data in the storage of the target host 122’ (S1130). Even in this process, data are stored from the shared memory of the CXL switch device 110’ directly to the storage of the target host 122’ without the process of storing data in the memory of the target host 122’.

In the embodiment described with reference to FIGS. 5 to 11, the access of each host to the memory may be minimized by using the CXL interface as the high-speed communication interface and implementing the shared memory in the CXL switch device.

This may make low-latency replica possible. That is, the CXL interface allows the storage (e.g., an SSD) of the host to be treated like a host memory address space, and thus, the replica may be quickly performed without passing through a network stack.

Also, it may be possible to provide efficient background data rebalancing. That is, because a storage access speed is increased between a plurality of nodes (e.g., hosts), the reduction of performance due to the data rebalancing process may be minimized.

In addition, a data path may be simplified. That is, because the data transmission path providing the direct connection such as “storage-CXL switch device-storage” is established, an existing network-based packet processing process may be omitted.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g., CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

According to embodiments of the present disclosure, it may be possible to improve a data replica process and a data rebalancing process by using a CXL device and to provide data replica and data rebalancing faster and more efficiently through a direct memory loading-based data processing function.

According to embodiments of the present disclosure, it may be possible to allow data loaded on a memory device to be directly replicated from the memory device to storage of a host, by mapping a plurality of storage present in different hosts through a common memory device by utilizing a CXL interface such that data processing is directly performed between the plurality of storage.

According to embodiments of the present disclosure, it may be possible to process data at a high speed without bottleneck by using Ethernet communication to transmit commands between a plurality of hosts and a CXL device and by utilizing a CXL interface for data processing.

Effects of the present disclosure are not limited to the above-described effects, and any other effects not mentioned herein may be clearly understood from this specification and the accompanying drawings by those skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents of the claims fall within the scope of the following claims.

What is claimed is:

1. A method for low-latency data processing based on distributed storage using a high-speed communication interface, which is performed in a distributed storage system including a plurality of hosts, the method comprising:
communicatively connecting a source host and a target host through a first communication interface and a second communication interface;
transmitting a command from the source host to the target host through the first communication interface; and
transmitting data to the target host from the source host through a shared memory of a switch device by using the second communication interface,
wherein a speed of the second communication interface is higher than a speed of the first communication interface, and
wherein a delay of the second communication interface is lower than a delay of the first communication interface.

2. The method of claim 1, wherein the first communication interface is a network interface card (NIC)-based communication interface, and
wherein the second communication interface is a compute express link (CXL)-based communication interface.

3. The method of claim 2, wherein the communicatively connecting of the source host and the target host through the first communication interface and the second communication interface includes:
communicatively connecting the source host and the target host by using the NIC-based communication interface; and
communicatively connecting the source host, the target host, and the switch device by using the CXL-based communication interface.

4. The method of claim 1, wherein the switch device internally includes the shared memory, and
wherein each of the source host and the target host includes storage individually.

5. The method of claim 4, wherein, when the data are transmitted to the target host from the source host through the shared memory of the switch device,
the data are stored from the shared memory of the switch device directly to storage of the source host without loading the data to a memory of the source host, or
the data are stored from the shared memory of the switch device directly to storage of the target host without loading the data to a memory of the target host.

6. The method of claim 1, wherein the transmitting of the data to the target host from the source host through the shared memory of the switch device includes:
loading first data received by the source host as a replica target to the shared memory of the switch device so as to be replicated to the source host and the target host.

7. The method of claim 6, wherein the loading of the first data received by the source host as the replica target to the shared memory of the switch device so as to be replicated to the source host and the target host includes:
receiving, at the source host, the first data from a client;
providing, at the source host, the first data to the switch device through the second communication interface, wherein the first data provided to the switch device are loaded to the shared memory by the switch device; and
receiving, at the source host, the first data loaded to the shared memory of the switch device from the switch device through the second communication interface so as to be directly stored to storage of the source host.

8. The method of claim 7, wherein the loading of the first data received by the source host as the replica target to the shared memory of the switch device so as to be replicated to the source host and the target host further includes:
receiving, at the target host, the first data loaded to the shared memory of the switch device from the switch device through the second communication interface so as to be directly stored to storage of the target host.

9. The method of claim 1, wherein the transmitting of the data to the target host from the source host through the shared memory of the switch device includes:
loading second data stored in storage of the source host as a rebalancing target to the shared memory of the switch device so as to be rebalanced to the target host.

10. The method of claim 9, wherein the loading of the second data stored in the storage of the source host as the rebalancing target to the shared memory of the switch device so as to be rebalanced to the target host includes:
loading the second data stored to the storage of the source host to the shared memory of the switch device through the second communication interface; and
receiving, at the target host, the second data loaded to the shared memory of the switch device from the switch device through the second communication interface so as to be directly stored to storage of the target host.

11. A system for low-latency data processing based on distributed storage using a high-speed communication interface, comprising:
a source host;
a target host communicatively connected to the source host through a first communication interface and a second communication interface; and
a switch device communicatively connected to the source host and the target host through the second communication interface and internally including a shared memory,
wherein a command is transmitted to the target host from the source host through the first communication interface, and
wherein data are transmitted to the target host from the source host through the shared memory of the switch device by using the second communication interface,
wherein a speed of the second communication interface is higher than a speed of the first communication interface, and
wherein a delay of the second communication interface is lower than a delay of the first communication interface.
